(19) United States
(12) Patent Application Publication
(10) Pub. No.: US 2006/0024603 A1
(43) Pub. Date: Feb. 2, 2006

(54) Toner and toner manufacturing method

(75) Inventor: Shuitsu Sato, Tokyo (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/168,444

(22) Filed: Jun. 29, 2005

(30) Foreign Application Priority Data
Jul. 29, 2004 (JP) 2004-221358

(51) Int. Cl. G03G 9/08

(52) U.S. Cl. 430/109.3; 430/109.4; 430/137.1; 430/108.1; 430/108.6; 430/108.7; 430/108.3

(57) ABSTRACT

In a toner of the present invention containing binder resin and a coloring agent, the toner is comprised a mixture of first toner and second toner which are different in the binder resin from each other, and only either of the first toner and second toner contains crystalline polyester resin.

### CROSS REFERENCE TO RELATED APPLICATION

This application is base upon and claims the benefit of priority from the prior Japanese Patent Application No. 2004-221358 filed on Jul. 29, 2004, the entire contents of which are incorporated herein by reference.

### FIELD OF THE INVENTION

The present invention relates to toner and a manufacturing method thereof used in a dry type electro-photographic apparatus such as a copier and a printer.

### DESCRIPTION OF THE BACKGROUND

In a dry type electro-photographic apparatus, the heating temperature for a fixing device when fixing a toner image on a sheet of paper is lowered, thus the consumption energy of the electro-photographic apparatus can be reduced greatly. Therefore, fixing at a lower temperature is desired strongly and study has been given greatly to improvement of the low temperature fixing property.

As an art for improving the lower temperature fixing property, for example, as disclosed in Japanese Patent Application Publication No. 2003-270853, it is known to use crystalline polyester resin as a binder resin material for toner.

By use of crystalline polyester resin as a binder resin material for toner, toner can be fixed at a lower temperature. However, crystalline polyester resin is hygroscopic, so that when crystalline polyester resin is used as a toner material, the so-called blocking phenomenon that toner makes contact mutually and is condensed occurs, thus a problem arises that the preservation property of toner is reduced. Further, when the hygroscopicity is high, a problem arises that the charging stability of toner in a humid environment is insufficient. Furthermore, in continuous printing, since low temperature fixing toner is apt to be softened, when a sheet of paper is ejected immediately after fixing, a phenomenon that the toner is transferred to the back of another sheet of paper occurs.

When the amount of crystalline polyester is reduced in consideration of these problems, for the improvement of the low temperature fixing property by use of crystalline polyester, sufficient results cannot be obtained.

### SUMMARY OF THE INVENTION

An object of the present invention is to provide toner which is good in the low temperature fixing property and excellent in the preservation property and charging stability and even in continuous printing, is prevented from transferring to the back.

According to the embodiments of the present invention, there is provided a toner containing binder resin and a coloring agent, wherein the toner comprises a mixture of first toner and second toner which are different in a component of the binder resin from each other and only either of the first toner and the second toner contains crystalline polyester resin.

Further, according to the embodiments of the present invention, there is provided a toner comprising first toner including a main component of binder resin containing at least one of amorphous polyester resin and styrene-acrylic resin and crystalline polyester resin and also containing a coloring agent; and second toner including a main component of binder resin containing at least one of amorphous polyester resin and styrene-acrylic resin and also containing a coloring agent.

Furthermore, according to the embodiments of the present invention, there is provided a toner manufacturing method comprising: obtaining first toner containing a coloring agent, first binder resin, and crystalline polyester resin; obtaining second toner containing a coloring agent and second binder resin different in a component from the first binder resin; adding a first additive to the first toner; adding a second additive different in a component from the first additive to the second toner; and mixing the first toner and the second toner.

### BRIEF DESCRIPTION OF THE DRAWINGS

FIG. 1 is a table indicating the composition of the first toner and second toner of the present invention;

FIG. 2 is a table indicating the components of the toner additives relating to the embodiments and comparison examples of the present invention;

FIG. 3 is a table indicating the toner composition relating to Embodiments 1 to 6 and Comparison examples 1 to 4;

FIG. 4 is a table indicating the toner manufacturing method relating to the embodiments and Comparison examples 1 to 4 of the present invention;

FIG. 5 is a table indicating the toner evaluation results relating to Embodiments 1 to 6 and Comparison examples 1 to 4;

FIG. 6 is a table indicating the toner composition relating to Embodiments 7 to 10;

FIG. 7 is a table indicating the toner evaluation results relating to Embodiments 7 to 10 of the present invention;

FIG. 8 is a table indicating the toner composition relating to Embodiments 11 to 17; and

FIG. 9 is a table indicating the toner evaluation results relating to Embodiments 11 to 17.

### DETAILED DESCRIPTION OF THE EMBODIMENTS

Hereinafter, the embodiments of the present invention will be explained.

The toner relating to the embodiments of the present invention is composed of first toner and second toner which are different in the binder resin material from each other.

The first toner contains crystalline polyester resin as binder resin. On the other hand, the second binder resin contains no crystalline polyester resin and is composed of, for example, amorphous polyester resin and styrene acrylic resin.

Hereinafter, the resin material used in the embodiments will be explained first.

(1) Manufacture of Amorphous Polyester Resin a:

50 parts of BPA-PO (propylene oxide additive of bisphenol A), 20 parts of BPA-EO (ethylene oxide additive of bisphenol A), 14 parts of terephthalic acid, 12 parts of dodecenylsuccinic anhydride, 8 parts of anhydrous trimellitic acid, and 5 parts of dibutyltin oxide are mixed and polymerized in a container at 210° C. to 230° C. for eight hours. The container is decompressed slowly and evacuated to 8 kPa, and the polymerization is further continued, and amorphous polyester resin having a softening point of 148° C. is obtained.

(2) Manufacture of Amorphous Polyester Resin b:

75 parts of BPA-PO (propylene oxide additive of bisphenol A), 10 parts of terephthalic acid, 20 parts of fumaric acid, and 5 parts of dibutyltin oxide are mixed and polymerized in a container at 210° C. to 230° C. for eight hours. The container is decompressed slowly and evacuated to 8 kPa, and the polymerization is further continued, and amorphous polyester resin having a softening point of 101° C. is obtained.

(3) Manufacture of Crystalline Polyester Resin:

95 parts of 1,4-butanediol, 5 parts of glycerine, 100 parts of fumaric acid, and 5 parts of hydroquinone are mixed and reacted at 150° C. to 170° C. for five hours, and then the container is heated to 200° C., decompressed slowly to continue the reaction for one hour, and evacuated to 8 kPa, and then the reaction is continued additionally for one hour, and crystalline polyester resin having a melting point of 125° C. is obtained.

(4) Manufacture of Styrene Acrylic Resin:

85 parts of styrene, 15 parts of buthyl acrylate, and 0.2 parts of di-t-buthyl peroxide telephthalate are mixed, and air is replaced with nitrogen, and the parts are polymerized at 85° C. for 10 hours. Thereafter, the parts are polymerized at 95° C. for 3 hours, and after cooling, the reactant is filtered and rinsed, and then dried at 50° C., and styrene acrylic resin having a softening point of 120° C. is obtained.

Further, crystalline polyester resin has a crystalline part in the resin and the crystallinity is generally 50% or lower. Crystalline polyester resin, when heated, has an area where the viscosity is suddenly reduced, while amorphous polyester resin, as the temperature rises, has a wide temperature area where the viscosity is slowly reduced, and in respect of it, amorphous polyester resin and crystalline polyester resin are distinguished from each other.

In addition to the resin materials manufactured in this way, the following articles are prepared.

As wax, two kinds of wax such as vegetable wax (Rice Wax by NS Chemical, Ltd.) and polypropylene wax (NPO55 by Mitsui Chemicals, Inc.) are prepared. As a charging control agent, a Zr complex compound (TN-105 by Hodogaya Chemical Co., Ltd.) is prepared and as a coloring agent, carbon black (NIPEX90 by Degussa Japan Co., Ltd) is prepared.

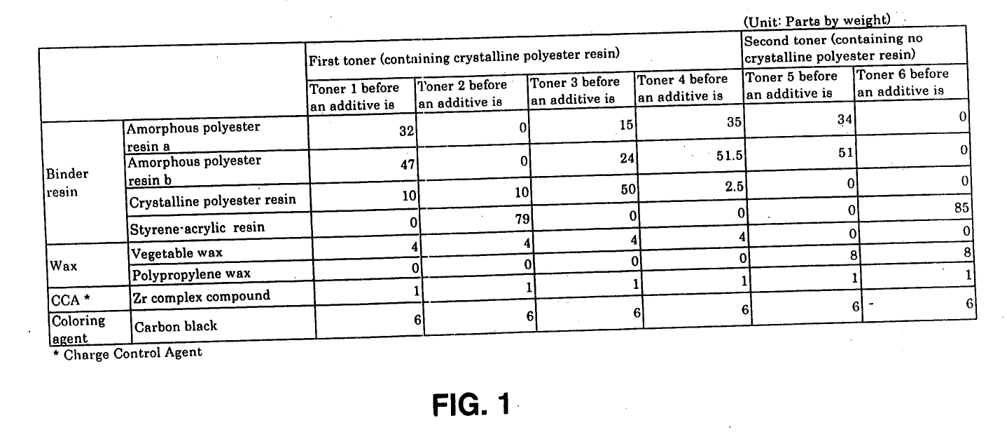

Using these materials, at the ratios shown in FIG. 1, six kinds of toner materials are prepared. To manufacture powder as mother particles of toner by these prepared materials, the respective materials are mixed by a Henschel mixer kind by kind and then are fused and mixed by a biaxial extruder. The fused mixture obtained is cooled, ground down roughly by a hammer mill, and then classified by a jet grinder, and powder 8 μm in size is obtained. The obtained powder is respectively named toner 1 before an additive is added to toner 6 before an additive is added. Among them, the first to fourth toner before an additive is added contain crystalline polyester resin, though the fifth and sixth toner before an additive is added contain no crystalline polyester resin. The first to fourth toner containing crystalline polyester are referred to as first toner and the fifth and sixth toner containing no crystalline polyester are referred to as second toner.

Next, using the first to sixth toner before an additive is added, various printing toner is manufactured. These toner will be explained as toner relating to the embodiments and comparison examples.

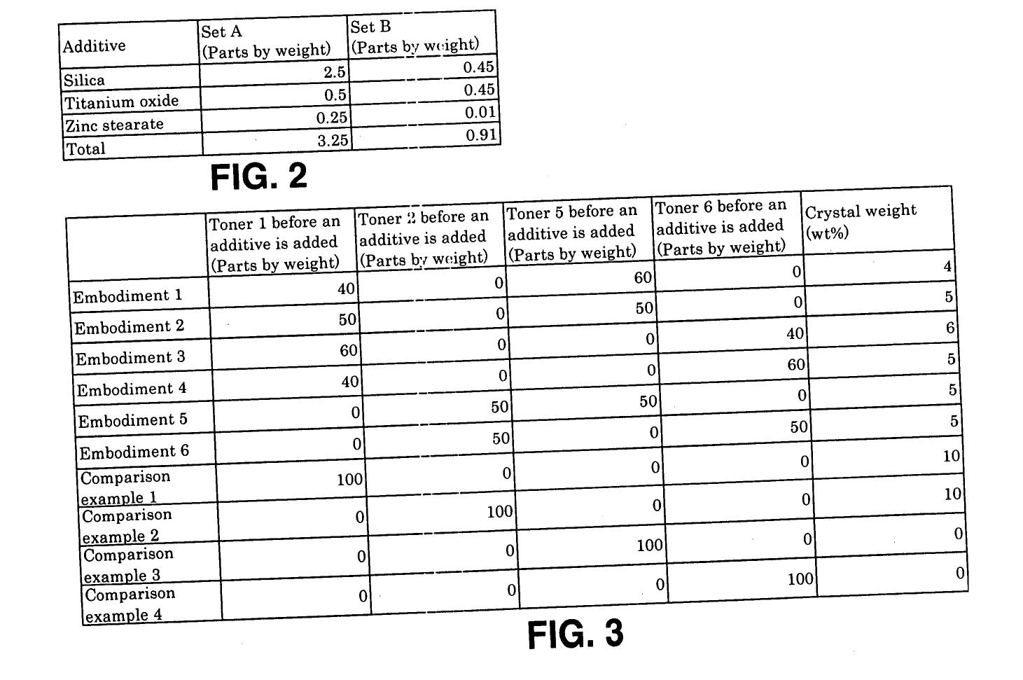

FIG. 2 shows the additives prepared to manufacture printing toner. As shown in FIG. 2, silica (NAX50 by Nippon Aerosil Co., Ltd.), titanium oxide (NK90 by Nippon Aerosil Co., Ltd.), and zinc stearate (by Nihon Yushi, Ltd.) are used as an additive and two kinds of additives such as additive set A and additive set B which are different in the composition ratio.

### Embodiment 1

As shown in FIG. 3, using toner 1 before an additive is added as first toner and toner 5 before an additive is added as second toner, toner of 100 parts by weight in total at a rate of 4 to 6 is prepared.

As a toner additive, additive set A shown in FIG. 2 is used. Namely, 2.5 parts by weight of silica, 0.5 parts by weight of titanium oxide, and 0.25 parts by weight of zinc stearate are used as an additive.

And, toner 1 before an additive is added, toner 5 before an additive is added, and additive set A are all put into a mixing bath of a Henschel mixer at a time and a stirring blade in the Henschel mixer is rotated at 30 m/s for 10 minutes. By this method, the mixing of toner and the additive addition process are finished and toner relating to Embodiment 1 is obtained.

### Embodiment 2

As shown in FIG. 3, using toner 1 before an additive is added as first toner and toner 5 before an additive is added as second toner, toner of 100 parts by weight in total at a rate of 5 to 5 is prepared.

Similarly to Embodiment 1, toner 1 before an additive is added, toner 5 before an additive is added, and additive set A are mixed in the Henschel mixer and toner relating to Embodiment 2 is obtained.

### Embodiment 3

As shown in FIG. 3, using toner 1 before an additive is added as first toner and toner 6 before an additive is added as second toner, toner of 100 parts by weight in total at a rate of 6 to 4 is prepared.

Similarly to Embodiment 1, toner 1 before an additive is added, toner 6 before an additive is added, and additive set A are mixed in the Henschel mixer and toner relating to Embodiment 3 is obtained.

### Embodiment 4

As shown in FIG. 3, using toner 1 before an additive is added as first toner and toner 6 before an additive is added as second toner, toner of 100 parts by weight in total at a rate of 4 to 6 is prepared.

Similarly to Embodiment 1, toner 1 before an additive is added, toner 6 before an additive is added, and additive set A are mixed in the Henschel mixer and toner relating to Embodiment 4 is obtained.

### Embodiment 5

As shown in FIG. 3, using toner 2 before an additive is added as first toner and toner 5 before an additive is added as second toner, toner of 100 parts by weight in total at a rate of 5 to 5 is prepared.

Similarly to Embodiment 1, toner 2 before an additive is added, toner 5 before an additive is added, and additive set A are mixed in the Henschel mixer and toner relating to Embodiment 5 is obtained.

### Embodiment 6

As shown in FIG. 3, using toner 2 before an additive is added as first toner and toner 6 before an additive is added as second toner, toner of 100 parts by weight in total at a rate of 5 to 5 is prepared.

Similarly to Embodiment 1, toner 2 before an additive is added, toner 6 before an additive is added, and additive set A are mixed in the Henschel mixer and toner relating to Embodiment 6 is obtained.

### Comparison Example 1

As shown in FIG. 3, 100 parts by weight of toner 1 before an additive is added is prepared, and toner 1 before an additive is added and additive set A are mixed in the Henschel mixer similarly to Embodiment 1, and toner relating to Comparison example 1 is obtained.

Comparison Example 2

100 parts by weight of toner 2 before an additive is added is prepared, and toner 2 before an additive is added and additive set A are mixed in the Henschel mixer similarly to Embodiment 1, and toner relating to Comparison example 2 is obtained.

### Comparison Example 3

100 parts by weight of toner 5 before an additive is added is prepared, and toner 5 before an additive is added and additive set A are mixed in the Henschel mixer similarly to Embodiment 1, and toner relating to Comparison example 3 is obtained.

### Comparison Example 4

100 parts by weight of toner 6 before an additive is added is prepared, and toner 6 before an additive is added and additive set A are mixed in the Henschel mixer similarly to Embodiment 1, and toner relating to Comparison example 4 is obtained.

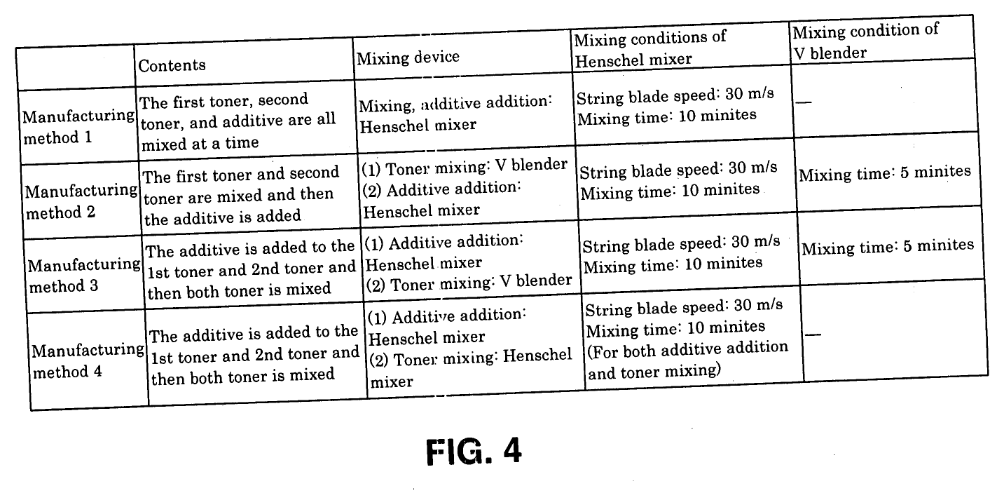

Further, the toner relating to Embodiments 1 to 6 and Comparison examples 1 to 4 aforementioned is all manufactured by Manufacturing method 1 among the four manufacturing methods shown in FIG. 4 under the same condition.

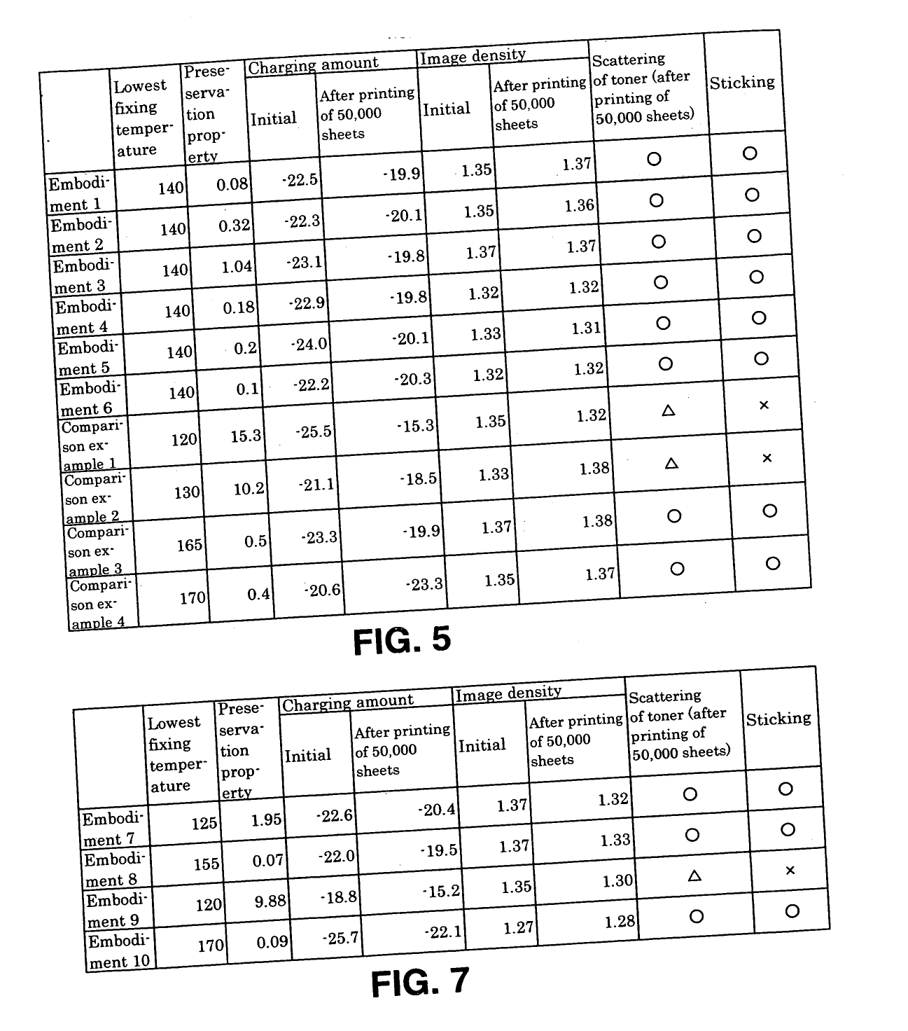

The evaluation results of the toner relating to Embodiments 1 to 6 and Comparison examples 1 to 4 aforementioned are shown in FIG. 5.

For evaluation, 8 parts by weight of the toner relating to each of the embodiments and comparison examples are mixed with 92 parts by weight of ferrite carrier coated with silicone with an average diameter of 40 μm to form a developer. Each developer is mounted in a copier Premage DP4503JPD, which is modified, manufactured by Toshiba Tech, Ltd. and is printed and evaluated.

The evaluation items are indicated below.

(1) Lowest Fixing Temperature:

While raising the temperature of the mixing unit of the copier sequentially to 90° C. to 240° C., according to predetermined image data, a toner image is fixed on a sheet of paper. On the image fixed through the fixing unit, a rubbing member with a load of 300 g having an attached cotton pad moves back and forth 5 times using a fastness testing machine (by Daiei Kagaku Seiki mFG. Co., Ltd.). The image before and after rubbing is measured by a reflection densitometer RD-917 (by Macbeth, Ltd.) and among the image fixing temperatures when the ratios (image density after rubbing/image density before rubbing) of the image before and after rubbing are higher than 70%, the lowest temperature is defined as a lowest fixing temperature. The lowest fixing temperature is preferably 160° C. or lower.

(2) Preservation Property of Toner:

Toner of 20 g relating to each of the embodiments and comparison examples is put into a bottle of 100 cc, is covered with a lid, is fixed to a jig, is put into a thermostatic chamber (BK-42 type by Yamato Scientific Co., Ltd.) set at a water temperature of 55° C., is left as it is for 8 hours, then is tapped 3 times using a powder tester (by Hosokawa Micron Corporation), and is put through a sieve of 42-mesh. Thereafter, the powder tester is vibrated for 10 seconds and the toner amount left on the sieve is measured. When the toner amount measured is 2 g or smaller, it is defined as satisfactory and when the toner amount measured is larger than 2 g, the preservation property is defined as unsatisfactory.

(3) Charging Amount of Toner:

Each toner is mixed with a carrier to form a developer and before using it for printing, a fixed amount is sampled. The sampled developer is put into blow-off charging amount measuring instrument TB-220 (by Kyocera Chemical Corporation) and the initial charging amount is measured. Next, the developer is put into the copier and on the basis of predetermined image data, 50,000 sheets are printed continuously. After continuous printing, the charging amount of the developer is measured in the same way as with the initial charging amount and the initial charging amount is compared with the charging amount after continuous printing. When the difference between the two charging amounts is 5 μC or larger or the absolute value of the charging amount after printing of 50,000 sheets is 10 μC/g or smaller, the chargeability is judged as unsatisfactory and in the other cases, the chargeability is judged as satisfactory.

(4) Image Density:

In the initial state immediately after the developer is put into the copier and printing is started, the solid printed parts of images on three sheets printed are measured by the reflection densitometer and the mean value thereof is defined as image density. After 50,000 sheets are printed continuously, in the same way as in the initial state, the image density is measured. When the image density is 1.3 or higher, it is defined as satisfactory and when the image density is lower than 1.3, it is defined as unsatisfactory.

(5) Scattering of Toner:

After continuous printing of 50,000 sheets, the inside of the copier is observed, and when no soil due to scattering of toner is recognized in the copier, it is assigned O, and when soil due to scattering of toner is recognized in the copier, it is assigned Δ, and when soil due to accumulation of toner is recognized in the copier, it is assigned X.

(6) Sticking of Images:

Continuous printing is executed, and the images passing the fixing unit are stacked up in a paper ejection unit of the copier, are kept as they are, and are cooled down to the room temperature, and then whether the image is transferred to the back of each sheet of paper or not and sheets of paper stick to each other or not are checked. When sticking of sheets of paper or image transfer to the back occurs, X is assigned and in the other cases, O is assigned.

FIG. 5 shows the evaluation results. As shown in FIG. 5, in the toner relating to Embodiment 1 to Embodiment 6, the lowest fixing temperature is 140° C., and the preservation property, toner charging amount, and image density test are satisfactory, and scattering of toner and sticking of images are not recognized.

On the other hand, in the toner relating to Comparison examples 1 and 2, although the fixing property is satisfactory, the preservation property and sticking property are bad, and scattering of toner is observed. In the toner relating to Comparison examples 3 and 4, the fixing property is inferior.

From the aforementioned, when the first toner containing crystalline polyester resin is used, it is found that toner having a low fixing temperature is obtained. However, in toner composed of only the first toner, there is a problem imposed in the preservation property and in toner not containing inversely the first toner, the fixing property is inferior.

On the other hand, in a mixture of the first toner and second toner, the balance between the fixing property and the preservation property is superior, and the chargeability is stable, and scattering of toner is little.

The reason seems to be that there exists toner containing no crystalline polyester around toner containing crystalline polyester resin, so that the first toner is prevented from mutual contact, thus the hygroscopicity of the first toner is practically reduced. Therefore, when the first toner and second toner are mixed and used as developer toner, the low temperature fixing improving function originally possessed by crystalline polyester resin is maintained, and the problem of reduction in the chargeability due to the hygroscopicity of crystalline polyester resin is solved, and superior toner can be obtained.

The mixing ratio of the first toner to the second toner is preferably 2:3 to 3:2 or so when the amount of crystalline polyester resin contained in the first toner is 2.5 parts by weight to 50 parts by weight. When the amount of crystalline polyester resin contained in the first toner is smaller than 2.5 parts by weight, the low temperature fixing property improving effect by crystalline polyester resin is insufficient, while when the amount of crystalline polyester resin is larger than 50 parts by weight, the chargeability of the toner is degraded due to the hygroscopicity of crystalline polyester resin. Further, from a view point of preventing the first toner from mutual sticking, the mixing ratio of the first toner to the second toner is preferably closer to 1:1 and the ratio of 2:3 to 3:2 or so is the mixable range.

Next, the toner relating to Embodiments 7 to 10 will be explained.

### Embodiment 7

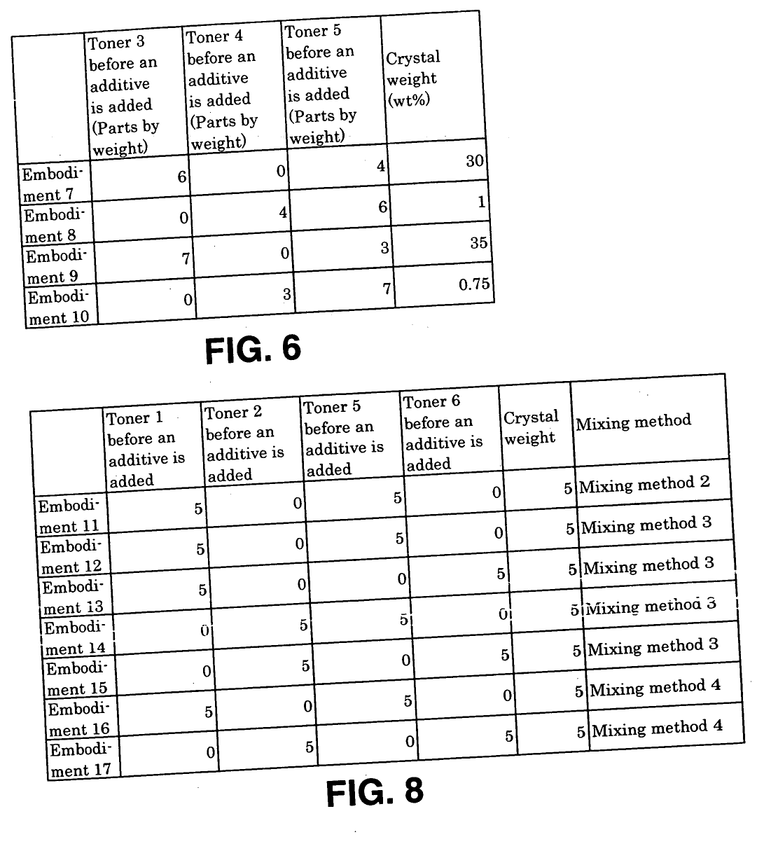

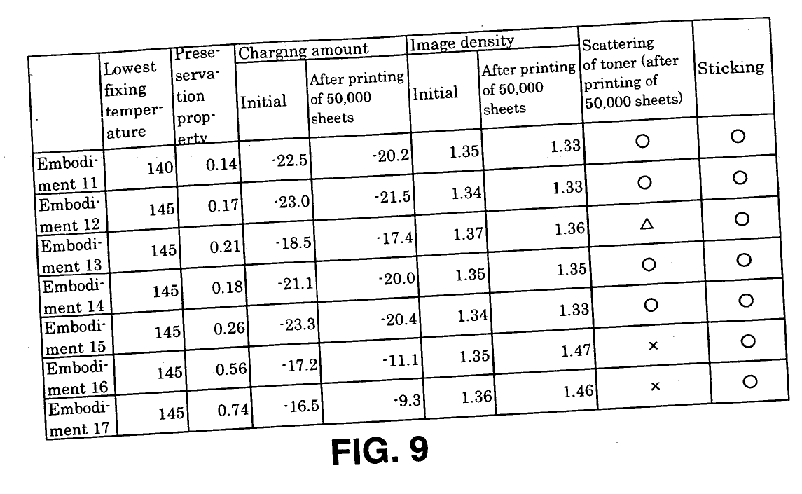

As shown in FIG. 6, toner 3 before an additive is added as first toner and toner 5 before an additive is added as second toner are prepared so as to obtain 100 parts by weight in total by mixing both toner at a rate of 6 to 4. Similarly to Embodiment 1, these toner and additive set A are mixed in the Henschel mixer, and the additive addition process is performed simultaneously with mixing, and toner relating to Embodiment 7 is obtained.

### Embodiment 8

As shown in FIG. 6, toner 4 before an additive is added as first toner and toner 5 before an additive is added as second toner are prepared so as to obtain 100 parts by weight in total by mixing both toner at a rate of 4 to 6. Similarly to Embodiment 1, these toner and additive set A are mixed in the Henschel mixer, and the additive addition process is performed simultaneously with mixing, and toner relating to Embodiment 8 is obtained.

### Embodiment 9

As shown in FIG. 6, toner 3 before an additive is added as first toner and toner 5 before an additive is added as second toner are prepared so as to obtain 100 parts by weight in total by mixing both toner at a rate of 7 to 3. Similarly to Embodiment 1, these toner and additive set A are mixed in the Henschel mixer, and the additive addition process is performed simultaneously with mixing, and toner relating to Embodiment 9 is obtained.

### Embodiment 10

As shown in FIG. 6, toner 4 before an additive is added as first toner and toner 5 before an additive is added as second toner are prepared so as to obtain 100 parts by weight in total by mixing both toner at a rate of 3 to 7. Similarly to Embodiment 1, these toner and additive set A are mixed in the Henschel mixer, and the additive addition process is performed simultaneously with mixing, and toner relating to Embodiment 10 is obtained.

To manufacture the toner relating to Embodiments 7 to 10, similarly to Embodiment 1, the method for mixing all the first toner, second toner, and additive in the Henschel mixer at a time is adopted.

The amount of crystalline polyester resin contained in the toner relating to Embodiments 7 to 10 is also shown in FIG. 6.

Further, the results of evaluation of the toner relating to Embodiments 7 to 10 executed in the same way as with Embodiment 1 are shown in FIG. 7. In the toner relating to Embodiments 7 and 8, the lowest fixing temperature is within the range from 120 to 160° C., and the preservation property, toner charging amount, and image density test are satisfactory, and scattering of toner and sticking of images are not recognized, and good results are produced. In Embodiment 9, the results of the preservation property test are bad and after printing of 50,000 sheets, scattering of toner and sticking of images are slightly recognized. In Embodiment 10, the lowest fixing temperature is slightly high such as 170° C. and the image density test shows that the density is slightly low in the initial state and after printing of 50,000 sheets. These differences seem to greatly depend on the content of crystalline polyester resin and the amount of crystalline polyester resin contained in the mixture of the first toner and second toner may be the to be approximately within the range from 1 to 30 parts by weight.

Next, the toner relating to Embodiments 11 to 17 will be explained by referring to FIG. 8. The toner relating to Embodiments 11 to 17 is manufactured by various manufacturing methods shown in FIG. 4 and the manufacturing methods are compared.

### Embodiment 11

As shown in FIG. 8, toner 1 before an additive is added as first toner and toner 5 before an additive is added as second toner are prepared so as to obtain 100 parts by weight in total by mixing both toner at a rate of 5 to 5. According to Manufacturing method 2 shown in FIG. 4, both toner is mixed by a V blender for 5 minutes, and then the mixed toner and additive set A are mixed in the Henschel mixer for 10 minutes, and toner relating to Embodiment 11 is obtained.

### Embodiment 12

As shown in FIG. 8, toner 1 before an additive is added as first toner and toner 5 before an additive is added as second toner are prepared so as to obtain 100 parts by weight in total by mixing both toner at a rate of 5 to 5. According to Manufacturing method 3 shown in FIG. 4, the first toner is stirred in the Henschel mixer together with additive set A at a stirring blade speed of 30 m/s for 10 minutes. The second toner is stirred in the Henschel mixer together with additive set B at a stirring blade speed of 30 m/s for 10 minutes and the additive addition process is performed.

Each toner finishing the processing of the additive in this way is mixed by the V blender for 5 minutes and toner relating to Embodiment 12 is obtained.

### Embodiment 13

As shown in FIG. 8, toner 1 before an additive is added as first toner and toner 6 before an additive is added as second toner are prepared so as to obtain 100 parts by weight in total by mixing both toner at a rate of 5 to 5. Similarly to Embodiment 12, by Manufacturing method 3 shown in FIG. 4, the additive addition process and toner mixing process are finished and toner relating to Embodiment 13 is obtained.

### Embodiment 14

As shown in FIG. 8, toner 2 before an additive is added as first toner and toner 3 before an additive is added as second toner are prepared so as to obtain 100 parts by weight in total by mixing both toner at a rate of 5 to 5. Similarly to Embodiment 12, by Manufacturing method 3 shown in FIG. 4, the additive addition process and toner mixing process are finished and toner relating to Embodiment 14 is obtained.

### Embodiment 15

As shown in FIG. 8, toner 1 before an additive is added as first toner and toner 6 before an additive is added as second toner are prepared so as to obtain 100 parts by weight in total by mixing both toner at a rate of 5 to 5. Similarly to Embodiment 12, by Manufacturing method 3 shown in FIG. 4, the additive addition process and toner mixing process are finished and toner relating to Embodiment 15 is obtained.

### Embodiment 16

As shown in FIG. 8, toner 1 before an additive is added as first toner and toner 5 before an additive is added as second toner are prepared so as to obtain 100 parts by weight in total by mixing both toner at a rate of 5 to 5. According to Manufacturing method 4 shown in FIG. 4, firstly, the first toner and additive set A are stirred in the Henschel mixer at a stirring blade speed of 30 m/s for 10 minutes. Next, the second toner and additive set B are stirred in the Henschel mixer at a stirring blade speed of 30 m/s for 10 minutes. Each toner obtained in this way is mixed in the Henschel mixer for 5 minutes and toner relating to Embodiment 16 is obtained.

### Embodiment 17

As shown in FIG. 8, toner 2 before an additive is added as first toner and toner 6 before an additive is added as second toner are prepared so as to obtain 100 parts by weight in total by mixing both toner at a rate of 5 to 5. Similarly to Embodiment 16, by Manufacturing method 4 shown in FIG. 4, the additive addition process and toner mixing process are executed and toner relating to Embodiment 17 is obtained.

With respect to the toner additive addition process and mixing process, several methods are conceivable. Namely, (1) a method for mixing the first toner, second toner, and additive all at a time and performing the additive addition process simultaneously with mixing (Manufacturing method 1 shown in FIG. 4), (2) a method for mixing two kinds of toner such as the first toner and second toner and then performing the additive addition process (Manufacturing method 2 shown in FIG. 4), and (3) a method for separately executing the additive addition process to the first toner and the additive addition process to the second toner and then mixing the two kinds of toner (Manufacturing methods 3 and 4 shown in FIG. 4) may be cited. The first toner and second toner use different resins, so that it is desirable to perform an additive addition process corresponding to each resin and from this point of view, the manufacturing method described in (3) is most suitable for the present invention.

At that time, the device used for the additive addition process and the device used for the mixing process are preferably different from each other and as a device used for the additive addition process, the Henschel mixer, a microspeed mixer, or a turbo-mixer in which the stirring blade rotates at high speed and the mixing speed is high is preferably used. On the other hand, for the mixing process, rather than the Henschel mixer, the V blender or an S blender in which the mixing strength is weak is desirably used. The reason is that when the mixing force at the time of the additive addition process is insufficient, the additive is separated from the toner surface after the processing, and particularly toner containing crystalline polyester resin is easily affected by humidity, thus the long-term stability of the chargeability is impaired. On the other hand, when toner is stirred with strong stirring force at the time of toner mixing, the adhesion state of the additive to the toner surface becomes too strong and the toner fluidity is impaired. From this reason, among Manufacturing methods 1 to 4 shown in FIG. 4, the most appropriate method is Manufacturing method 3.

Further, in a method such as Manufacturing method 3, the amount of an additive to each of the first toner and second toner can be changed freely. The first toner containing crystalline polyester resin has high hygroscopicity and the fixable temperature is often lower than that of the second toner. Due to such a difference, toner may not be charged and fixed uniformly. Therefore, in the first toner and second toner, by changing the additive kind and amount, the chargeability and fixing property can be improved. Generally, the amount of additive to the first toner is preferably larger than the amount of additive to the second toner.

Further, the materials used in the present invention are not limited to those described in the embodiments aforementioned and various materials can be used.

Crystalline polyester resin is obtained, for example, by using a monomer containing a carboxylic acid component composed of a multivalent (bivalent or higher) carboxylic acid compound and an alcohol component composed of multivalent (bivalent or higher) alcohol.

As an acid component, fumaric acid, maleic acid, citraconic acid, itaconic acid, glutaconic acid, phthalic acid, isophthalic acid, terephthalic acid, cychlohexanedicarboxylic acid, succinic acid, adipic acid, sebacic acid, and azelaic acid may be used.

As an alcohol component, ethylene glycol, propylene glycol, 1,4-butanediole, 1,3-butanediole, 1,5-pentanediole, 1,6-hexanediole, neopentyl glycol, glycerine, trimethylolethane, and trimethylolpropane may be used.

Particularly, a compound having alkyl radical of carbon number 16 or more or alkenyl radical and a crystalline compound generally in a wax form obtained by condensing and polymerizing an alcohol component containing 80 mol % or more of diole of carbon number 2 to 6 and a carboxylic acid component containing 80 mol % or more of fumaric acid are preferable. These compounds may be used individually or as a mixture of two or more kinds.

As wax, low molecular weight polyethylene, low molecular weight polypropylene, polyoelfin copolymer, polyolefin wax, microcrystalline wax, paraffin wax, carnauba wax, and rice wax may be used.

As a coloring agent, carbon black and organic or inorganic pigments and dyes may be used.

As carbon black, acetylene black, furnace black, thermal black, channel black, and ketchen black may be used.

Further, as pigment, for example, first yellow G, benzidine yellow, indofast orange, Irgazine red, carmine FB, permanent bordeaux FRR, pigment orange R, lithol red 2G, lake red C, rhodamine FB, rhodamine B lake, phthalocyanine blue, pigment blue, Brilliant green, phthalocyanine green, and quinacridone may be used individually or as a mixture.

As a charging control agent, for example, when a coloring agent is carbon black or an achromatic pigment or dye, a metallized azoic compound containing at least one of the group of a complex and a complex salt of iron, cobalt, and chromium may be preferably used. Further, when the coloring agent is a chromatic pigment or dye, a metallized salicylic acid derivative compound containing at least one of the group of a complex and a complex salt of zirconium, zinc, chromium, and boron may be used.

To adjust the flowability and chargeability, inorganic fine particles of 0.2 to 3 wt % can be mixed with toner particles. As such inorganic fine particles, silica, titania, alumina, titaniac acid strontium, and tin oxide may be used individually or as a mixture of two kinds or more.

Use of inorganic fine particles surface-treated by a hydrophobic agent beforehand is preferable from a viewpoint of improvement of the environment stability. Further, with toner particles, in addition to such an inorganic oxide, resin particles with a diameter of 1 μm or smaller may be mixed for improvement of the cleaning property.

Additionally, within a scope which is not deviated from the object of the present invention, the present invention may be modified variously.

As explained above, the toner of the present invention is composed of first toner and second toner which are different in the binder resin from each other and is structured so as to contain crystalline polyester resin only in the first toner, so that good results can be obtained that the low temperature fixing property is satisfactory, and the preservation property and charging stability are superior, and in continuous printing, toner is not transferred to the back of each sheet of paper.

What is claimed is:

1. A toner containing binder resin and a coloring agent, wherein the toner comprises a mixture of first toner and second toner which are different in a component of the binder resin from each other and only either of the first toner and the second toner contains crystalline polyester resin.

2. The toner according to claim 1, wherein when an amount of the crystalline polyester resin contained in the first toner is 2.5 to 50 parts by weight, a mixing ratio of the first toner to the second toner is 2:3 to 3:2.

3. The toner according to claim 1, wherein a weight ratio of the crystalline polyester resin occupied in a total weight of the toner is 1 to 30 wt %.

4. The toner according to claim 1, wherein the first toner is added with a first additive and the second toner is added with a second additive different from the first additive.

5. The toner according to claim 4, wherein an added amount of the first additive is larger than an added amount of the second additive.

6. A toner comprising:
first toner including a main component of binder resin containing at least one of amorphous polyester resin and styrene-acrylic resin and crystalline polyester resin and also containing a coloring agent; and
second toner including a main component of binder resin containing at least one of amorphous polyester resin and styrene-acrylic resin and also containing a coloring agent.

7. The toner according to claim 6, wherein when an amount of the crystalline polyester resin contained in the first toner is 2.5 to 50 parts by weight, a mixing ratio of the first toner to the second toner is 2:3 to 3:2.

8. The toner according to claim 6, wherein a weight ratio of the crystalline polyester resin occupied in a total weight of the toner is 1 to 30 wt %.

9. The toner according to claim 6, wherein the first toner is added with a first additive and the second toner is added with a second additive different from the first additive.

10. The toner according to claim 9, wherein an added amount of the first additive is larger than an added amount of the second additive.

11. A toner manufacturing method comprising:
obtaining first toner containing a coloring agent, first binder resin, and crystalline polyester resin;
obtaining second toner containing a coloring agent and second binder resin different in a component from the first binder resin;
adding a first additive to the first toner;
adding a second additive different in a component from the first additive to the second toner; and
mixing the first toner and the second toner.

12. The toner manufacturing method according to claim 11, wherein a weight ratio of the crystalline polyester resin occupied in a total weight of the toner is 1 to 30 wt %.

13. The toner manufacturing method according to claim 11, wherein an added amount of the first additive is larger than an added amount of the second additive.

14. The toner manufacturing method according to claim 11, wherein adding of the first additive to the first toner, adding of the second additive different in a component from the first additive to the second toner, and mixing of the first toner and the second toner are all executed at a time.

15. The toner manufacturing method according to claim 11, wherein mixing of the first toner and the second toner is executed, and then adding of the first additive to the first toner and adding of the second additive different in a component from the first additive to the second toner are executed.

16. The toner manufacturing method according to claim 11, wherein adding of the first additive to the first toner and adding of the second additive different in a component from the first additive to the second toner are executed and then mixing of the first toner and the second toner is executed.

17. The toner manufacturing method according to claim 11, wherein the first binder resin contains at least either of styrene-acrylic resin and amorphous polyester resin.

18. The toner manufacturing method according to claim 11, wherein the second binder resin contains at least either of styrene-acrylic resin and amorphous polyester resin.
